(19) United States
(12) Patent Application Publication
(10) Pub. No.: US 2014/0014033 A1
(43) Pub. Date: Jan. 16, 2014

(54) ORGANIC SOLUTION SUPPLY NOZZLE AND COATING APPARATUS INCLUDING THE SAME

(71) Applicant: Samsung Electronics Co., Ltd., Suwon-si (KR)

(72) Inventors: JUNG-HOON KIM, Hwaseong-si (KR); JIN-A RYU, Hwaseong-si (KR); JI-MAN PARK, Hwaseong-si (KR); JAE-HYUN KIM, Yongin-si (KR); DONG-JUN LEE, Seoul (KR)

(21) Appl. No.: 13/940,268

(22) Filed: Jul. 12, 2013

(30) Foreign Application Priority Data
Jul. 16, 2012 (KR) 10-2012-0077280

(51) Int. Cl. B05C 5/02

(52) U.S. Cl. CPC B05C 5/02
USPC 118/300; 118/302

(57) ABSTRACT

An organic solution coating apparatus is provided. The organic solution coating apparatus includes a rotary chuck having an upper surface on which a target is adsorbed and fixed, an organic solution supply nozzle configured to supply an organic solution to the target and having an inner surface having a contact angle with the organic solution of 90° or greater; and a nozzle standby unit in which the organic solution supply nozzle performs a preliminary spraying operation while the coating process is not performed, the nozzle standby unit including a nozzle standby hole having a surface having a contact angle with the organic solution of 90° or greater.

### CROSS-REFERENCE TO RELATED APPLICATION

This application claims priority under 35 U.S.C. §119 to Korean Patent Application No. 10-2012-0077280 filed on Jul. 16, 2012, the disclosure of which is hereby incorporated by reference in its entirety.

### BACKGROUND

1. Field

The present disclosure relates to an organic solution supply nozzle having a highly oil-repellent (olleophoic) surface or super oil-repellent surface, an organic solution coating apparatus including the organic solution supply nozzle and a nozzle standby unit, and a method of using the apparatus.

2. Description of Related Art

In a process of coating a wafer or a glass substrate with an organic solution such as photoresist, coating defects may occur due to particles remaining in an organic solution supply nozzle. Various apparatuses and methods have been suggested to address the defective coating problem.

### SUMMARY

Embodiments disclosed herein provide an organic solution supply nozzle.

Embodiments disclosed herein provide an organic solution coating apparatus including an organic solution supply nozzle and a nozzle standby unit.

The technical objectives of the inventive concept are not limited to the above disclosure; other objectives may become apparent to those of ordinary skill in the art based on the following descriptions.

In one embodiment, An organic solution coating apparatus is disclosed. The An organic solution coating apparatus includes: a nozzle including a supply tube and nozzle tip for spraying an organic solution onto a substrate; a nozzle standby hole for housing the nozzle when a spraying operation for depositing material onto substrate is not being performed; The nozzle may have an inner surface that causes the organic solution remaining at the nozzle tip after the spraying to have a contact angle of 90° or more with the inner surface, and the nozzle standby hole may have a surface that causes the organic solution remaining in the nozzle standby hole to have a contact angle of 90° or more with the surface.

In one embodiment, the nozzle performs a preliminary spraying of the organic solution when the nozzle is housed in the nozzle standby hole, and the nozzle standby hole is cleaned by using a cleaning solution, to remove organic solution remaining in the standby hole after the preliminary spraying.

The inner surface may have nano-sized fine structures, and the nano-sized fine structures may be realized by coating or adsorbing nano-sized nano-particles or fibers of nano-diameters on a target surface, or by etching the target surface.

The inner surface having the nano-sized fine structures may have a surface energy that is less than 5 mN/m, and to do this, a chemical material such as fluorinated polyhedral oligomeric silsesquioxane or fluorinated trichlorosilane may be used.

The nozzle tip may be coupled to an end portion of the supply tube, and may comprise one or more exit holes.

In one embodiment, the supply tube and nozzle tip are formed non-reactive material selected from the group including glass, stainless steel, and Teflon.

In one embodiment, the organic solution is a photoresist.

In accordance with another embodiment, An organic solution coating apparatus includes: a nozzle including a supply tube and nozzle tip for spraying an organic solution onto a substrate; a nozzle standby hole for housing the nozzle when a spraying operation for depositing material onto the substrate is not being performed. The nozzle tip may have an inner surface that prevents the organic solution from sticking to the nozzle tip; and the nozzle standby hole may have a surface that prevents the organic solution from sticking to the nozzle standby hole.

In one embodiment, the An organic solution coating apparatus includes the nozzle performs a preliminary spraying of the organic solution when the nozzle is housed in the nozzle standby hole. The nozzle standby hole is cleaned by using a cleaning solution, to remove organic solution remaining in the standby hole after the preliminary spraying.

In one embodiment, the inner surface of the nozzle causes the organic solution remaining at the nozzle tip after the spraying to have a contact angle of 90° or more with the inner surface, and the surface of the nozzle standby hole causes the organic solution remaining in the nozzle standby hole to have a contact angle of 90° or more with the surface.

In one embodiment, the nozzle tip has an inner surface having a nano-scale roughness formed of fibers of nano-sized diameters or nano-sized particles. The inner surface of the nozzle tip may be processed by a chemical material so as to have a surface energy that is less than 5 mN/m.

In a further embodiment, an organic solution coating apparatus includes: a rotary chuck having an upper surface on which a target is adsorbed and fixed; and an organic solution supply nozzle configured to supply an organic solution to the target, and having an inner surface having a contact angle with the organic surface of 90° or greater, and a nozzle standby unit in which the organic solution supply nozzle performs a preliminary spraying operation while the coating process is not performed, the nozzle standby unit having a nozzle standby hole having a surface having a contact angle with the organic solution of 90° or greater.

In one embodiment, the organic solution supply nozzle includes a supply tube configured to supply the organic solution and having an internal surface having a contact angle with the organic solution of 90° or greater, and a nozzle tip coupled to an end portion of the supply tube and having an internal surface having a contact angle with the organic solution of 90° or greater.

In one embodiment, the nozzle standby unit includes a main body comprising the nozzle standby hole for receiving the organic solution supply nozzle, the nozzle standby hole penetrating the main body in a vertical direction; and a cleaning liquid supplying line connected to a lower portion of the main body to supply a cleaning liquid to a lower portion of the nozzle standby hole.

### BRIEF DESCRIPTION OF THE DRAWINGS

The foregoing and other features and advantages disclosed herein will be apparent from the more particular description of various embodiments, as illustrated in the accompanying drawings in which like reference characters refer to the same or similar parts throughout the different views. The drawings are not necessarily to scale, emphasis instead being placed upon illustrating the principles of the inventive concepts. In the drawings:

FIG. 1 is a longitudinal sectional view schematically showing an organic solution coating apparatus in accordance with certain exemplary embodiments;

FIG. 2 is a longitudinal sectional view of a nozzle standby unit in accordance with certain exemplary embodiments;

FIGS. 3A and 3B are schematic longitudinal sectional views of a supply nozzle of an organic solution coating apparatus in accordance with certain exemplary embodiments;

FIG. 4A is a longitudinal sectional view schematically showing a suck-back phenomenon of an organic solution into a general organic solution supply nozzle;

FIG. 4B is a longitudinal sectional view schematically showing a receded state of an organic solution in an organic solution supply nozzle in accordance with certain exemplary embodiments;

FIG. 4C is an exemplary cross-sectional view of portion A of FIG. 4B, which is expanded and rotated by an angle of 90°;

FIG. 5 is a flowchart illustrating a coating process using an organic solution coating apparatus in accordance with certain exemplary embodiments; and

FIG. 6 is a flowchart illustrating an exemplary method of manufacturing a semiconductor device using an organic solution coating apparatus, in accordance with certain disclosed embodiments.

### DETAILED DESCRIPTION OF THE EMBODIMENTS

Various embodiments will now be described more fully with reference to the accompanying drawings in which some embodiments are shown. The inventive concepts may, however, be embodied in different forms and should not be construed as limited to the embodiments set forth herein. In the drawings, the sizes and relative sizes of layers and regions may be exaggerated for clarity.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. Unless indicated otherwise, these terms are only used to distinguish one element from another. For example, a first chip could be termed a second chip, and, similarly, a second chip could be termed a first chip without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Embodiments described herein will be described referring to plan views and/or cross-sectional views by way of ideal schematic views. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures have schematic properties, and shapes of regions shown in figures exemplify specific shapes of regions of elements, and the specific properties and shapes do not limit aspects of the invention.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

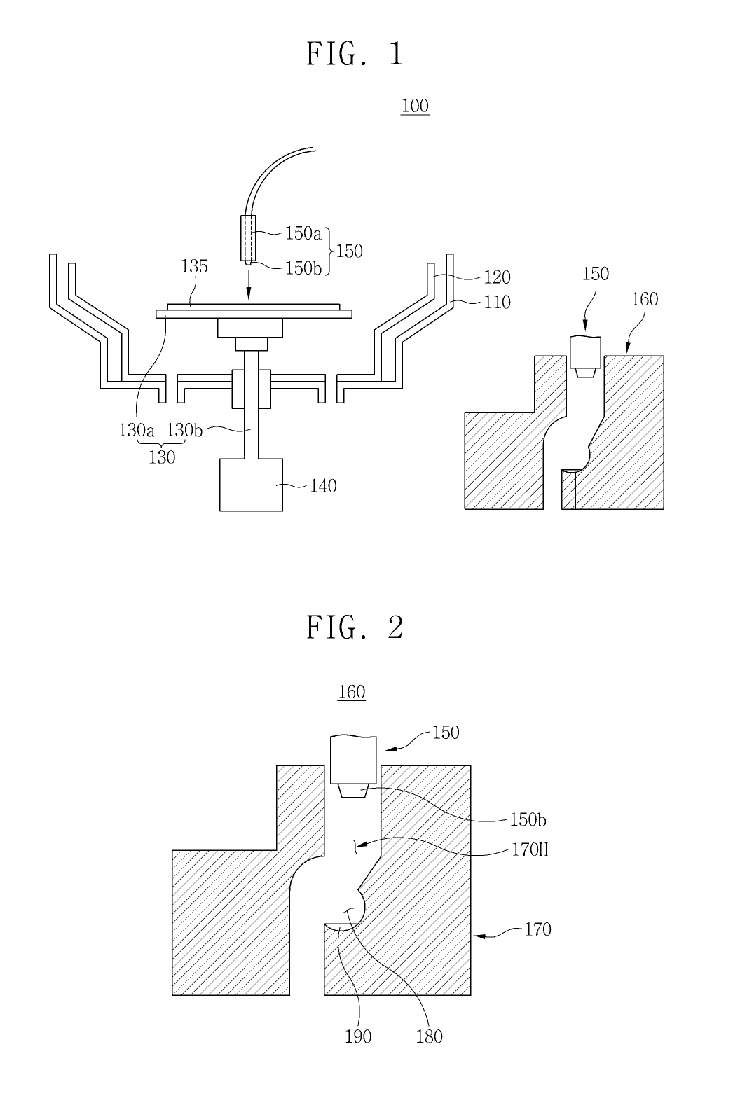

FIG. 1 is a schematic longitudinal sectional view of an organic solution coating apparatus 100 in accordance with certain exemplary embodiments, and FIG. 2 is a longitudinal sectional view of a nozzle standby unit 160 in accordance with certain exemplary embodiments.

Referring to FIG. 1, the organic solution coating apparatus 100 in accordance with one embodiment may include a main body 110 formed as a cylinder with an open upper portion, a spin structure 130 configured to penetrate through the main body 110 in a vertical direction, a driving unit 140 located under the spin structure 130, a bowl 120 formed as a cylinder located between the main body 110 and the spin structure 130 to prevent an organic solution from splattering outwards, an organic solution supply nozzle 150 for supplying the organic solution, and a nozzle standby unit 160 in which the organic solution supply nozzle 150 performs a preliminary spraying operation while the coating process is not performed.

The spin structure 130 may include, for example, a rotary chuck 130a and a rotary axis 130b coupled to the rotary chuck 130a. The rotary axis 130b may be rotated while coupled to the driving unit 140, and the rotary chuck 130a may fixedly adsorb a substrate 135 on which a coating process will be performed.

For example, a target substrate 135 such as a wafer or glass may be vacuum adsorbed and fixed on an upper portion of the rotary chuck 130a. The target substrate 135 may be, for example, a substrate used in a semiconductor device, such as a semiconductor package substrate, a semiconductor chip substrate, an interposer substrate, a PCB substrate, or other type of substrate. In one embodiment, the substrate is formed of a semiconductor material, such as silicon.

The bowl 120 may prevent the organic solution from staining the main body 110 or splattering outwards during a spin process, and may be detached to be cleaned.

The bowl 120 may be formed of, for example, Teflon.

In one embodiment, the organic solution supply nozzle 150 includes a supply tube 150a for supplying the organic solution, and a nozzle tip 150b formed at an end portion of the supply tube 150a.

The nozzle tip 150b may include an exit (e.g., an opening) for supplying the organic solution. The exit may be a single hole, or in other embodiments, the exit may include a plurality of exit holes. The supply tube 150a and the nozzle tip 150b of the organic solution supply nozzle 150 may be formed of, for example, one selected from the group consisting of non-reactive and/or oxidation resistant materials including glass, stainless steel, or Teflon.

Also, the supply tube 150a and the nozzle tip 150b of the organic solution supply nozzle 150 may have a super oil-repellent surface that prevents wetting or largely reduces wetting with respect to the organic solution. The super oil-repellent surface will be described in more detail later.

Referring to FIG. 2, the nozzle standby unit 160 may include a main body 170 that is perforated in a vertical direction thereof and includes a nozzle standby hole 170H, in which the organic solution supply nozzle 150 may be lowered to a predetermined depth, and a cleaning liquid supply line 180 disposed at a lower portion of the nozzle standby hole 170H to supply a cleaning liquid 190 to the lower portion of the nozzle standby hole 170H.

In one embodiment, the organic solution supply nozzle 150 is located in the nozzle standby hole 170H when a film forming process is not performed. Here, the nozzle tip 150b may be located in the nozzle standby hole 170H.

For example, in one embodiment, the organic solution supply nozzle 150 is placed in the nozzle standby unit 160 before and/or after the coating process to perform a preliminary spraying operation.

In one embodiment, the preliminary spraying operation is performed in order to remove a solidified portion of the organic solution that is sucked back into the nozzle 150, and to remove particles stained on an inner surface of the nozzle 150.

The cleaning liquid 190 may be supplied to the lower portion of the nozzle standby hole 170H to remove photoresist stained on a surface of the nozzle standby hole 170H. The cleaning liquid 190 may include thinner, for example. In addition, in one embodiment, the surface of the nozzle standby hole 170H in the nozzle standby unit 160 may have super oil-repellent properties.

As a result, the sprayed organic solution does not remain on the surface of the nozzle standby hole 170H, but flows to the lower portion of the nozzle standby hole 170H. Thus, the amount of cleaning liquid 190 for removing the organic solution remaining on the surface of the nozzle standby hole 170H may be reduced.

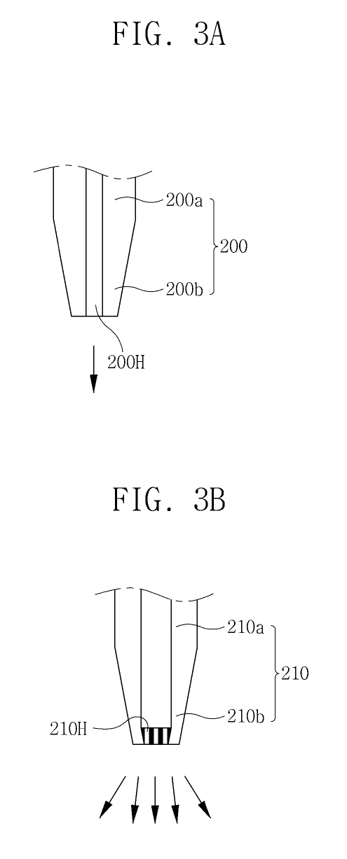

FIGS. 3A and 3B are schematic longitudinal sectional views showing organic solution supply nozzles 200 and 210 of an organic solution coating apparatus in accordance with another exemplary embodiment.

Referring to FIG. 3A, the organic solution supply nozzle 200 according to one embodiment includes a supply tube 200a for supplying the organic solution, and a nozzle tip 200b formed at an end portion of the supply tube 200a.

The nozzle tip 200b may include a single exit hole 200H for supplying the organic solution to the substrate In one embodiment, the outside of the nozzle tip 200b is tapered, and the inner surface in the nozzle tip 200b through which the organic solution travels on its way toward the exit hole 200H is straight (e.g., includes straight surfaces extending along the direction the organic solution travels).

Referring to FIG. 3B, the organic solution supply nozzle 210 according to another embodiment includes a supply tube 210a for supplying the organic solution, and a nozzle tip 210b formed at an end portion of the supply tube 210a and including a plurality of exit holes 210H. When the nozzle tip 210b includes the plurality of exit holes 210H, spraying pressure of the organic solution may be adjusted to be higher, and thus, the organic solution may be evenly sprayed to a wider area than that of FIG. 3A. The shape of the organic solution supply nozzle according to the inventive concept is not limited to the examples shown in FIGS. 3A and 3B.

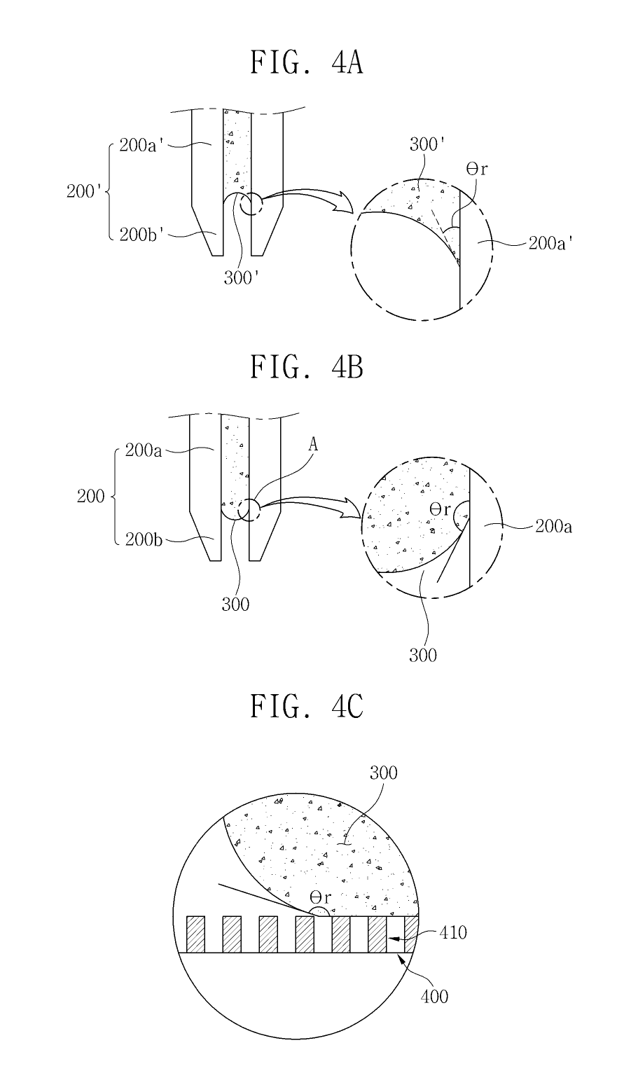

According to the organic solution supply nozzle 200 or 210 of the above-described embodiments, internal surfaces of the organic solution supply tube 200a or 210a and the nozzle tip 200b or 210b may have a super oil-repellent property. This will be described in more detail with reference to FIGS. 4A and 4B.

FIG. 4A is a longitudinal sectional view schematically showing a suck-back state of an organic solution into a general organic solution supply nozzle, FIG. 4B is an exemplary longitudinal sectional view schematically showing a suck-back state of an organic solution into the organic solution supply nozzle in accordance with the disclosed embodiments, and FIG. 4C is an exemplary expanded cross-sectional view showing portion A of FIG. 4B after being rotated at an angle of 90°.

Referring to FIGS. 4A and 4B, organic solutions 300′ and 300 that are sucked back into the supply tubes 200a′ and 200a that are formed as narrow cylinders, may be receded in two ways. One of the two receding ways is that the organic solution 300′ is receded concavely in the supply tube 220a′ with respect to the exit of the supply tube, and the other is that the organic solution 300 is receded convexly in the supply tube 220a with respect to the exit of the supply tube.

According to the example in which the organic solution 300′ is concavely receded, the contact angle between the receded organic solution 300′ and a surface of the supply tube 200a′ (receding angle, θr, at the liquid-solid-air interface) is less than 90°. According to the exemplary embodiment in which the organic solution 300 is convexly receded, the contact angle between the receded organic solution 300 and a surface of the supply tube 200a (receding angle, θr, at the liquid-solid-air interface) is equal to or greater than 90°.

In a case where the contact angle θr is equal to or less than 90°, the organic solution 300′ is more strongly stuck to the surface of the supply tube 200a′ as shown in FIG. 4A. Thus, residual drops may remain on the surface of the supply tube 200a′ while the organic solution 300′ recedes, which may harden, thus causing spraying imbalances and/or requiring more cleaning agent to remove. However, when the contact angle θr is equal to or greater than 90°, the organic solution 300 does not stick to the surface of the supply tube 200a as shown in FIG. 4B, and no residual drops remain on the surface of the supply tube 200a.

In one embodiment, in order to increase the contact angle θr to 90° or greater, the internal surfaces of the supply tube 200a and the nozzle tip 200b, which contact the organic solution 300, are surfaces having low wetting and low surface energy, such as super oil-repellent surfaces.

Referring to FIG. 4C, in order for a surface 400 contacting the organic solution 300 to have more effective oil-repellent properties, a fine structure 410 of a micro or nano-size is formed. In addition, a surface may be selected to have a surface energy to be 5 Mn/m or less.

When the nano-sized fine structure 410 is formed on the surface 400 and the surface energy is reduced, a Cassie-Baxter mode may be formed between the organic solution 300 and the surface 400 contacting thereto. The Cassie-Baxter mode denotes a state where air is trapped in an interface between the organic solution 300 and the surface 400, thereby increasing the contact angle θr between the organic solution 300 and the surface 400 rapidly to 90° or greater, and also denotes a state where wetting of the organic solution 300 on the surface 400 may be restrained. Therefore, if the surface is slanted, the organic solution drops slide downwards on contacting the surface. Although a threshold angle of 90° is described above, surfaces having particular types of super oil-repellant properties can cause higher contact angles, such as 120° or 150°, to result in an even fewer residual drops remaining on the surface within a nozzle tip or supply tube of a nozzle.

In one embodiment, a method of forming a highly oil-repellent surface includes forming a nano-sized fine structure by etching a surface of a target (e.g., the supply tube and the nozzle tip of the organic solution supply nozzle, and the nozzle standby hole of the nozzle standby unit), and reducing the surface energy by a chemical process. In one embodiment, forming a highly oil-repellant surface includes forming a surface having nano-scale roughness by distributing fibers of nano-diameters or nano-sized particles on the surface, and reducing the surface energy by a chemical process. One or both of these processes may be used. In one embodiment, the nano-structure of a material used may have a cross-sectional structure of the fine nano-structure shown in FIG. 4C, and the distance between adjacent nano-sized elements (e.g., fibers or particles) or the height adjacent nano-sized elements may vary.

A highly oil-repellant material or super oil-repellent material (e.g., a material that causes at least a 90° contact angle with an organic solution) may be fabricated by mixing a chemical material in which fluorine group is substituted with a sol containing particles having nano-diameters such as polymer, silica nano-particles, or chrome oxide nano-particles, and a surface having low surface energy and nano-scale roughness may be formed by using the above material.

If a target surface is a glass material, for example, an oil repellent material in which silica nano-particles and fluorinated tricholorosilane are mixed with each other may be used. In addition, if a target surface is a stainless steel material, for example, an oil repellent material in which chrome oxide nano-particles and fluorinated tricholorosilane are mixed with each other may be used.

If a target surface is formed of Teflon, for example, a super oil-repellent surface may be obtained by etching the target surface, performing a plasma process on the etched surface, and coating the plasma processed surface with fluorinated tricholorosilane.

The fluorinated trichlorosilane reduces surface energy, and as another example, fluorinated polyhedral oligomeric silsesquioxane may be used. Molecules of such a material form covalent bonds with the target surface. In addition, since the above material has no reactivity to the organic solution, the above materials are not dissolved by the organic solution and thus are chemically stabilized.

As described above, the method of forming the nano-sized fine structures by directly etching the surface may include a plasma etching method using plasma.

Also, the method of coating the target surface with the fibers of nano-diameters or the particles of nano-diameters may selectively use one of a plurality of methods including a spin coating method, an electrostatic adsorbing method, a method of depositing plasmatized mixture gas on the target surface, and a dip coating method.

The method of forming the nano-scale roughness on the target surface is not limited to the above-described methods. Other methods for forming the nano-scale roughness on the completed structure such as the supply tube 200a or the nozzle tip 200b of the organic solution supply nozzle 200, or the nozzle standby hole 170H (refer to FIG. 2) of the nozzle standby unit, may be used, and such methods may include or not include the above described dip coating method, the method of depositing plasmatized mixture gas, and the electrostatic adsorbing method. The chemical process for reducing surface energy may include the dip coating method and a vapor phase reaction.

Therefore, by performing a process of applying the nano-sized fine structures on the surface 400 and performing a chemical process on the surface 400 to reduce surface energy, the organic solution supply nozzle 200 including the supply tube 200a and the nozzle tip 200b, and the nozzle standby unit 170 (refer to FIG. 2) including the nozzle standby hole 170H (refer to FIG. 2) having highly or super oil-repellent surfaces in accordance with various disclosed embodiments, may be manufactured.

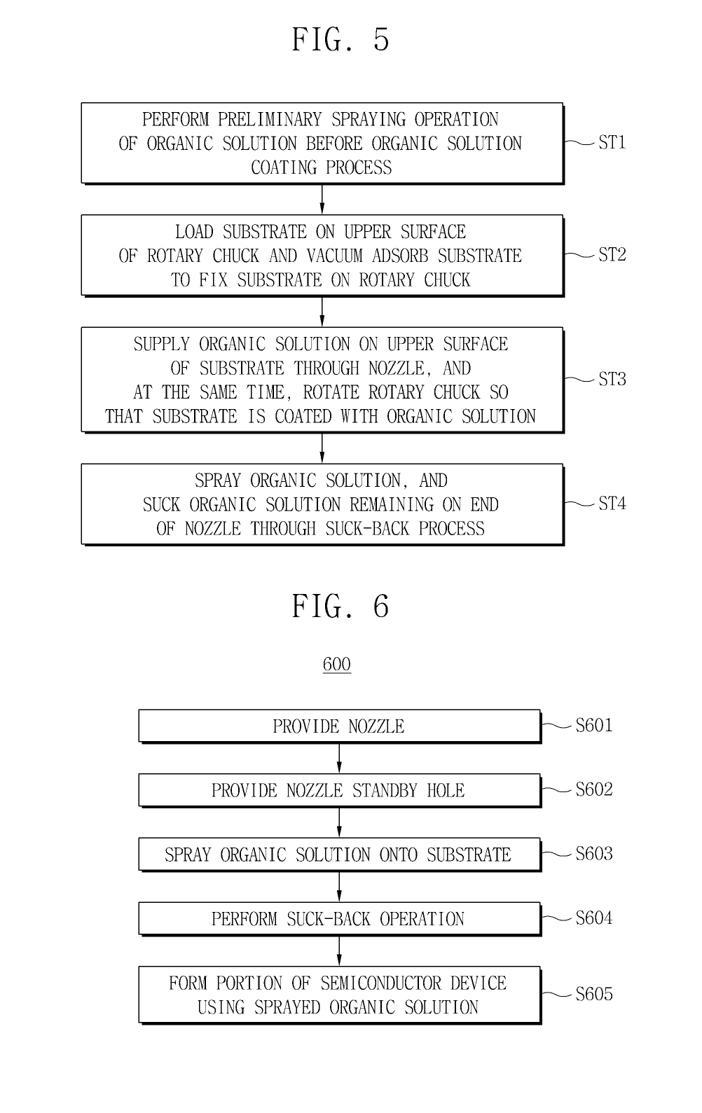

FIG. 5 is a flowchart describing coating processes of the organic solution coating apparatus in accordance with an exemplary embodiment.

Referring to FIGS. 1, 2, and 5, exemplary coating processes using the organic solution coating apparatus in accordance with certain exemplary embodiments will be described as follows.

First, before performing an organic solution coating process on the target substrate 135 (e.g., a wafer or glass substrate which may be part of a semiconductor device or other device), the spraying nozzle 150 accommodated in the nozzle standby unit 160 performs a preliminary spraying operation for spraying a predetermined amount of organic solution.

The preliminary spraying operation is performed to remove any solidified portion of the organic solution because diluents included in the organic solution may be volatilized during standby time, and at the same time, remove organic solution particles remaining on the internal surfaces of the supply tube 150a and the nozzle tip 150b, as described above.

Successively, an operation of spraying a cleaning liquid (thinner) for removing the organic solution sprayed into the nozzle standby hole 170H is performed (ST1).

Next, the substrate 135 is mounted on an upper surface of the rotary chuck 130b, and at the same time, the substrate 135 may be fixed by vacuum adsorbed by the upper surface of the rotary chuck 130b (ST2).

Next, the organic solution is supplied onto the substrate 135 through the organic solution supply nozzle 150, and at the same time, the rotary chuck 130b and the substrate 135 fixed on the rotary chuck 130b are rotated quickly by the rotary axis 130a connected to the driving unit 140 so that the surface of the substrate 135 may be evenly coated with the organic solution (ST3).

After spraying the organic solution on the substrate 135, a suck-back operation for sucking the organic solution remaining on the end of the nozzle tip 150b into the organic solution supply nozzle 150 may be performed (ST4).

Through the suck-back operation, the organic solution formed at the end portion of the nozzle tip 150b (e.g., formed on the inner surface, or at or just outside the exit hole) may be sucked into the organic solution supply nozzle 150, for example, into the supply tube 150a. As such, coating defects generated when the organic solution formed on the end portion of the organic solution supply nozzle 150 drops onto the surface of the substrate 135 may be prevented.

In one embodiment, since the internal surfaces of the supply tube 150a and the nozzle tip 150b have highly or super oil-repellent properties, residual drops of the organic solution do not remain on the internal surface of the end of the supply tube 150a and the internal surface of the nozzle tip 150b while the organic solution is sucked into the supply tube 150a.

Therefore, particles of the organic solution do not remain on the internal surfaces of the supply tube 150a and the nozzle tip 150b, and the amount of wasted organic solution while performing the preliminary spraying of the organic solution to remove the particles may be reduced to less than that of the conventional art.

Also, since the surface of the nozzle standby hole 170H of the nozzle standby unit 160 has highly or super oil-repellent properties, the preliminary sprayed organic solution may not remain on the surface of the nozzle standby hole 170H. Even if the organic solution remains on the surface of the nozzle standby hole 170H, the amount of the organic solution is minimized when being compared with that of the conventional art. Therefore, a lesser amount of thinner than that of the conventional art may be used to remove the remaining organic solution.

Also, if a process of spraying thinner onto the end portion of the organic solution supply nozzle 150 is performed in order to directly wash the organic solution supply nozzle 150, the amount of used thinner may be greatly reduced.

As described above, because of the oil-repellant properties of the organic solution supply nozzle in accordance with the various described embodiments, residual drops of the organic solution may be prevented from remaining on the surfaces of the supply tube and the nozzle tip included in the organic solution supply nozzle, as well as the nozzle standby hole.

Therefore, coating defects that may occur when particles formed of solidified organic solution drop onto the coated surface, may be prevented.

Also, as one of objectives of the preliminary spraying operation in the nozzle standby unit, a lot of organic solution is sprayed in order to remove residual drops of the organic solution built up in the organic solution nozzle. Here, the amount of wasted organic solution may be reduced, and at the same time, the amount of thinner for cleaning the organic solution may be reduced.

As described above, according to the disclosed embodiments, the coating defects may be prevented and the amount of wasted organic solution and thinner may be reduced, and accordingly, yield of the products may be improved and manufacturing costs may be reduced.

FIG. 6 is a flowchart illustrating an exemplary method 600 of manufacturing a semiconductor device using an organic solution coating apparatus, in accordance with certain disclosed embodiments. The semiconductor device may be, for example, a memory or processor chip or package, that may include one or more substrates, such as package substrates, chip substrates, a PCB substrate, etc.

In the embodiment shown in FIG. 6, in steps 601 and 602, a nozzle and a nozzle standby hole are provided. The nozzle and nozzle standby hole may have a structure, for example, consistent with one or more of the embodiments described above. For example, the nozzle may include a supply tube and nozzle tip for spraying an organic solution onto a substrate, and the nozzle standby hole may be used for housing the nozzle when a spraying operation for depositing material onto a substrate is not being performed (e.g., when the nozzle is not actively spraying material onto the substrate). The nozzle tip may have an inner surface that prevents the organic solution from sticking to the nozzle tip. In one embodiment, for example, the nozzle has an inner surface that causes the organic solution remaining at the nozzle tip after the spraying to have a contact angle of 90° or more with the inner surface. A bottom and outer surface of the nozzle tip may also have the same oil-repellent properties as the inner surface. Similarly, a surface of the nozzle standby hole may have a surface that prevents the organic solution from sticking to the nozzle standby hole. In one embodiment, for example, the nozzle standby hole has a surface that causes the organic solution remaining at the nozzle standby hole to have a contact angle of 90° or more with that surface. Although steps 601 and 602 are shown in a particular order, they may be performed concurrently or in the opposite order, according to certain embodiments.

In step 603, an organic solution is sprayed onto the substrate using the nozzle. In step 604, a suck-back operation is performed after spraying the organic solution onto the substrate to suck back organic solution remaining at the nozzle tip. As a result of the spraying operation, in step 605, at least a portion of a semiconductor device is formed using the sprayed organic solution. For example, if the organic solution is a photoresist, then the photoresist may be used to form certain layers and/or elements on a substrate (e.g., a wiring layer, insulation layer, or conductive pads on a semiconductor chip or package substrate).

Though not shown in FIG. 6, the method of manufacturing a semiconductor device may include additional steps. For example, in one embodiment, when the nozzle is housed in the nozzle standby unit, a preliminary spraying of the organic solution from the nozzle may be performed, according, for example, to one or more of the embodiments described above. Further, in one embodiment, a cleaning of the nozzle standby hole is performed using a cleaning solution, to remove organic solution remaining in the standby hole after the preliminary spraying. A cleaning of the nozzle tip may be performed as well.

Further steps may additionally occur, such as forming additional layers, elements, or parts of the semiconductor device. Some of these steps may additionally be performed using the exemplary apparatuses and methods described herein.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures.

What is claimed is:

1. An organic solution coating apparatus comprising:
a nozzle including a supply tube and nozzle tip for spraying an organic solution onto a substrate;
a nozzle standby hole for housing the nozzle when a spraying operation for depositing material onto the substrate is not being performed;
wherein the nozzle has an inner surface that causes the organic solution remaining at the nozzle tip after the spraying to have a contact angle of 90° or more with the inner surface, and
wherein the nozzle standby hole has a surface that causes the organic solution remaining in the nozzle standby hole to have a contact angle of 90° or more with the surface.

2. The organic solution coating apparatus of claim 1, wherein
the nozzle performs a preliminary spraying of the organic solution when the nozzle is housed in the nozzle standby hole.

3. The organic solution coating apparatus of claim 2,
wherein the nozzle standby hole is cleaned by using a cleaning solution, to remove organic solution remaining in the standby hole after the preliminary spraying.

4. The organic solution coating apparatus of claim 1, wherein the inner surface is a rough surface having nano-sized fine structures.

5. The organic solution coating apparatus of claim 4, wherein the nano-sized fine structures formed on the inner surface include nano-sized particles or fibers of nano-diameters.

6. The organic solution coating apparatus of claim 5, wherein the nano-sized particles include silica nano-particles or chrome oxide nano-particles.

7. The organic solution coating apparatus of claim 4, wherein the surface having the nano-sized fine structures is processed by a chemical material so as to have a surface energy that is less than 5 mN/m.

8. The organic solution coating apparatus of claim 7, wherein the chemical material includes fluorinated polyhedral oligomeric silsesquioxane, or fluorinated trichlorosilane.

9. The organic solution coating apparatus of claim 1, wherein the organic solution is a photoresist.

10. The organic solution coating apparatus of claim 1, wherein the nozzle tip is coupled to an end portion of the supply tube, and comprises one or a plurality of exit holes.

11. The organic solution coating apparatus of claim 1, wherein the supply tube and the nozzle tip are formed of a non-reactive material selected from the group including glass, stainless steel, and Teflon.

12. An organic solution coating apparatus comprising:
a nozzle including a supply tube and nozzle tip for spraying an organic solution onto a substrate;
a nozzle standby hole for housing the nozzle when a spraying operation for depositing material onto the substrate is not being performed;
wherein the nozzle tip has an inner surface that prevents the organic solution from sticking to the nozzle tip; and
wherein the nozzle standby hole has a surface that prevents the organic solution from sticking to the nozzle standby hole.

13. The organic solution coating apparatus of claim 12, wherein:
the inner surface of the nozzle causes the organic solution remaining at the nozzle tip after the spraying to have a contact angle of 90° or more with the inner surface, and
the surface of the nozzle standby hole causes the organic solution remaining in the nozzle standby hole to have a contact angle of 90° or more with the surface.

14. The organic solution coating apparatus of claim 12, wherein the nozzle tip has an inner surface having a nano-scale roughness formed of fibers of nano-sized diameters or nano-sized particles.

15. The method of claim 14, wherein the inner surface of the nozzle tip is processed by a chemical material so as to have a surface energy that is less than 5 mN/m.

16. An organic solution coating apparatus comprising:
a rotary chuck having an upper surface on which a target is adsorbed and fixed; an organic solution supply nozzle configured to supply an organic solution to the target and having an inner surface having a contact angle with the organic solution of 90° or greater; and
a nozzle standby unit in which the organic solution supply nozzle performs a preliminary spraying operation while the coating process is not performed, the nozzle standby unit including a nozzle standby hole having a surface having a contact angle with the organic solution of 90° or greater.

17. The organic solution coating apparatus of claim 16, wherein the organic solution supply nozzle comprises:
a supply tube configured to supply the organic solution and having an internal surface having a contact angle with the organic solution of 90° or greater; and
a nozzle tip coupled to an end portion of the supply tube and having an internal surface having a contact angle with the organic solution of 90° or greater.

18. The organic solution coating apparatus of claim 16, wherein the nozzle standby unit comprises:
a main body including the nozzle standby hole for receiving the organic solution supply nozzle, the nozzle standby hole penetrating the main body in a vertical direction; and
a cleaning liquid supplying line connected to a lower portion of the main body to supply a cleaning liquid to a lower portion of the nozzle standby hole.
